(19) United States
(12) Patent Application Publication
(10) Pub. No.: US 2021/0064636 A1
(43) Pub. Date: Mar. 4, 2021

(54) METHOD TO ANALYZE DATA

(71) Applicant: TmaxData Co., Ltd., Gyeonggi-do (KR)

(72) Inventors: Kyoungjun Park, Gyeonggi-do (KR); Youngkwang Lee, Gyeonggi-do (KR); Saemaro Moon, Gyeonggi-do (KR); Changho Hwang, Gyeonggi-do (KR)

(21) Appl. No.: 16/675,628

(22) Filed: Nov. 6, 2019

(30) Foreign Application Priority Data
Sep. 4, 2019 (KR) 10-2019-0109400

(51) Int. Cl. G06F 16/26; G06F 16/25; G06N 3/08

(52) U.S. Cl. CPC G06F 16/26; G06Q 10/105; G06N 3/08; G06F 16/252

(57) ABSTRACT

According to an exemplary embodiment of the present disclosure, disclosed is a computer program stored in a computer readable storage medium. When the computer program is executed in one or more processors of a computing device, the computer program performs operations for providing a method of analyzing data, the operations including: determining analysis target data based on a data set; determining an analysis scenario based on the analysis target data; and generating an analysis result for the analysis target data based on the analysis scenario.

### TECHNICAL FIELD

The present invention is for the purpose of providing a method of analyzing data, and more particularly, to a method of analyzing data stored in a database and generating an analysis result.

### BACKGROUND ART

Corporate business is expanding rapidly with the explosive increase in data and the emergence of diverse environments and platforms. As new business environments arrive, more efficient and flexible data service, information processing, and data management capabilities are needed. In line with these changes, research is ongoing on databases to solve high-performance, high-availability, and scalability problems which are the basis of the implementation of the enterprise business.

In a DataBase Management System (DBMS), data may be stored in a data storage place. When the database includes a large amount of data, a user may consume a large amount of time to determine which data to be analyzed in the data stored in the database or which data to be analyzed to produce what results.

Accordingly, there is a need in the art to provide a method of determining which of the data stored in the database needs to be analyzed and how the data needs to be analyzed to produce an analysis result.

Korean Patent No. 10-1648401 discloses a database management device for managing and analyzing data.

### SUMMARY OF THE INVENTION

The present disclosure is conceived in response to the background art, and has been made in an effort to provide a method of analyzing data.

An exemplary embodiment of the present disclosure for implementing the foregoing object provides a computer program stored in a computer readable storage medium, in which when the computer program is executed in one or more processors of a computing device, the computer program performs operations for providing a method of analyzing data, the operations including: determining analysis target data based on a data set; determining an analysis scenario based on the analysis target data; and generating an analysis result for the analysis target data based on the analysis scenario.

In an alternative exemplary embodiment of the operations of the computer program to perform the operations for providing the method of analyzing data, the determining of the analysis target data based on the data asset may include outputting the analysis target data by inputting the data set to an analysis target data determination model including one or more pre-trained network functions.

In the alternative exemplary embodiment of the operations of the computer program to perform the operations for providing the method of analyzing data, the outputting of the analysis target data by inputting the data set to the analysis target data determination model including one or more pre-trained network functions may include inputting at least one of an analysis purpose, user selection data, and user information as an additional input of the analysis target data determination model; and outputting the analysis target data by computing the data set and the additional input by using the analysis target data determination model.

In the alternative exemplary embodiment of the operations of the computer program to perform the operations for providing the method of analyzing data, the user information may include at least one of user general information including at least one of identification information for distinguishing a user from another user and group information including information about a group of the user, and user history information that is information on a data analysis characteristic of a user.

In the alternative exemplary embodiment of the operations of the computer program to perform the operations for providing the method of analyzing data, the analysis target data determination model may be a model trained by using training data including the data set as an input, at least one of an analysis purpose, user selection data, and user information as an additional input, and the analysis target data as a label.

In the alternative exemplary embodiment of the operations of the computer program to perform the operations for providing the method of analyzing data, the analysis target data determination model may be a model trained by using training data generated based on a feedback for the analysis target data of the users.

In the alternative exemplary embodiment of the operations of the computer program to perform the operations for providing the method of analyzing data, the analysis target data determination model may be the model trained for relevancy between two or more items included in the data set.

In the alternative exemplary embodiment of the operations of the computer program to perform the operations for providing the method of analyzing data, the analysis target data determination model may be the model trained for relevancy between the two or more items based on the analysis items included in the data analysis histories of the users.

In the alternative exemplary embodiment of the operations of the computer program to perform the operations for providing the method of analyzing data, the operations may further include determining a preprocessing method for the analysis target data in order to perform the analysis scenario.

In the alternative exemplary embodiment of the operations of the computer program to perform the operations for providing the method of analyzing data, the determining of the analysis scenario that is a user interested scenario based on the analysis target data may include determining the analysis scenario based on at least one of the characteristic of the analysis target data, the analysis purpose, and the user information.

In the alternative exemplary embodiment of the operations of the computer program to perform the operations for providing the method of analyzing data, the determining of the analysis scenario based on at least one of the characteristic of the analysis target data, the analysis purpose, and the user information may include at least one of: determining the analysis scenario based on an analysis scenario corresponding to at least one of information about the contents included in the analysis target data included in data analysis histories of the users and the analysis purpose; and determining the analysis scenario based on the analysis scenario included in the data analysis history of the user based on the user information.

In the alternative exemplary embodiment of the operations of the computer program to perform the operations for providing the method of analyzing data, the generating of the analysis result based on the analysis scenario may include generating the analysis result based on at least one of the characteristic of the analysis scenario, the analysis purpose, and the user information.

In the alternative exemplary embodiment of the operations of the computer program to perform the operations for providing the method of analyzing data, the data set may include data included in two or more heterogeneous databases.

In the alternative exemplary embodiment of the operations of the computer program to perform the operations for providing the method of analyzing data, the operations may further include performing the preprocessing of the data based on the kind of database in which the data included in the data set is stored.

In the alternative exemplary embodiment of the operations of the computer program to perform the operations for providing the method of analyzing data, the generating of the analysis result for the analysis target data based on the analysis scenario may include assigning a weight to anomaly data in one or more data included in the analysis target data and generating the analysis result.

Another exemplary embodiment of the present disclosure for implementing the foregoing object provides a method of analyzing data, the method including: determining analysis target data based on a data set; determining an analysis scenario based on the analysis target data; and generating an analysis result for the analysis target data based on the analysis scenario.

Another exemplary embodiment of the present disclosure for implementing the foregoing object provides a server for analyzing data, the server including: a processor including one or more cores; and a memory, in which the processor determines analysis target data based on a data set, determines an analysis scenario based on the analysis target data, and generates an analysis result for the analysis target data based on the analysis scenario.

The present disclosure may provide a method of analyzing data.

### BRIEF DESCRIPTION OF THE DRAWINGS

FIG. 1 is a block diagram of a computing device performing an operation for analyzing data according to an exemplary embodiment of the present disclosure.

FIG. 2 is a diagram illustrating an example of a method of analyzing data according to an exemplary embodiment of the present disclosure.

FIG. 3 is a flowchart of the method of analyzing data according to an exemplary embodiment of the present disclosure.

FIG. 4 is a block diagram of a computing device according to an exemplary embodiment of the present disclosure.

### DETAILED DESCRIPTION

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and the computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as Internet, through data and/or a signal from one component interacting with another component in a local system and a distributed system) having one or more data packets.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

A term “include” and/or “including” shall be understood as meaning that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations has been generally described above in the functional aspects thereof. Whether the functionality is implemented by hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present invention. Various modifications of the exemplary embodiments will be apparent to those skilled in the art. General principles defined herein may be applied to other exemplary embodiments without departing from the scope of the present disclosure. Accordingly, the present invention is not limited to the exemplary embodiments presented herein. The present invention shall be interpreted within the broadest meaning range consistent to the principles and new characteristics presented herein.

In an exemplary embodiment of the present disclosure, a server may also include other configurations for performing a server environment of the server. The server may include any type of device. The server is a digital device and may be a digital device, such as a laptop computer, a notebook computer, a desktop computer, a web pad, and a mobile phone, which is mounted with a processor, includes a memory, and has a calculation ability. The server may be a web server processing a service. The foregoing kind of server is merely an example, and the present disclosure is not limited thereto.

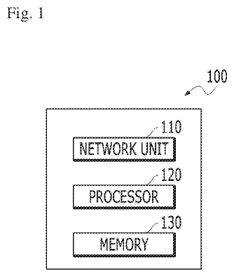

FIG. 1 is a block diagram of a computing device performing an operation for analyzing data according to an exemplary embodiment of the present disclosure.

A computing device 100 performing an operation for analyzing data according to an exemplary embodiment of the present disclosure may include a network unit 110, a processor 120, and a memory 130.

The network unit 110 may transceive data and the like for performing a data analysis according to the exemplary embodiment of the present disclosure with another computing device, a server, and the like. The network unit 110 may transceive data included in a heterogeneous data with another computing device, a server, and the like in order to perform a data analysis. Further, the network unit 110 enables a plurality of computing devices to communicate with each other, so that learning of a network function may be distributed and performed in each of the plurality of computing devices. The network unit 110 enables a plurality of computing devices to communicate with each other, so that a data analysis using a network function may be distributed and processed.

The network unit 110 according to the exemplary embodiment of the present disclosure may use various wired communication systems, such as a Public Switched Telephone Network (PSTN), an x Digital Subscriber Line (xDSL), a Rate Adaptive DSL (RADSL), a Multi Rate DSL (MDSL), a Very High speed DSL (VDSL), a Universal Asymmetric DSL (UADSL), a High Bit Rate DSL (HDSL), and a Local Area Network (LAN).

The network unit 110 presented in the present specification may use various wireless communication systems, such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems.

The network unit 110 according to the exemplary embodiments of the present disclosure may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth.

The technologies described in the present specification may also be used in other networks, as well as the foregoing networks.

The processor 120 may be formed of one or more cores, and may include a processor, such as a central processing unit (CPU), a general purpose graphics processing unit (GPGPU), and a tensor processing unit (TPU) of the computing device, for analyzing data and deep learning. The processor 120 may read a computer program stored in the memory 130 and perform a data analysis according to the exemplary embodiment of the present disclosure. According to the exemplary embodiment of the present disclosure, the processor 120 may perform a computation for learning of a neural network. The processor 120 may perform a calculation, such as processing of input data for learning in deep learning (DL), extraction of a feature from input data, an error calculation, update of a weighted value of the neural network by using backpropagation, for learning of the neural network. At least one of the CPU, GPGPU, and the TPU of the processor 120 may process learning of a network function. For example, the CPU and the GPGPU may process learning of a network function and a data analysis by using the network function together. Further, in the exemplary embodiment of the present disclosure, the learning of the network function and the data analysis by using the network function may be processed by using the processors of the plurality of computing devices together. Further, the computer program executed in the computing device according to the exemplary embodiment of the present disclosure may be a CPU, GPGPU, or TPU executable program.

According to the exemplary embodiment of the present disclosure, the memory 130 may store a predetermined form of information generated or determined by the processor 120 and a predetermined form of information received by the network unit 110.

According to the exemplary embodiment of the present disclosure, the memory 130 may include at least one type of storage medium among a flash memory type, a hard disk type, a multimedia card micro type, and the card type of memory (for example, an SD or XD memory), a Random Access Memory (RAM), a Static Random Access Memory (SRAM), a Read-Only Memory (ROM), an Electrically Erasable Programmable Read-only Memory (EEPROM), a Programmable Read-Only Memory (PROM), a magnetic memory, a magnetic disk, and an optical disk. The computing device 100 may be operated in association with a web storage which performs a storage function of the memory 130 on the Internet. The description of the foregoing memory is merely an example, and the present disclosure is not limited thereto.

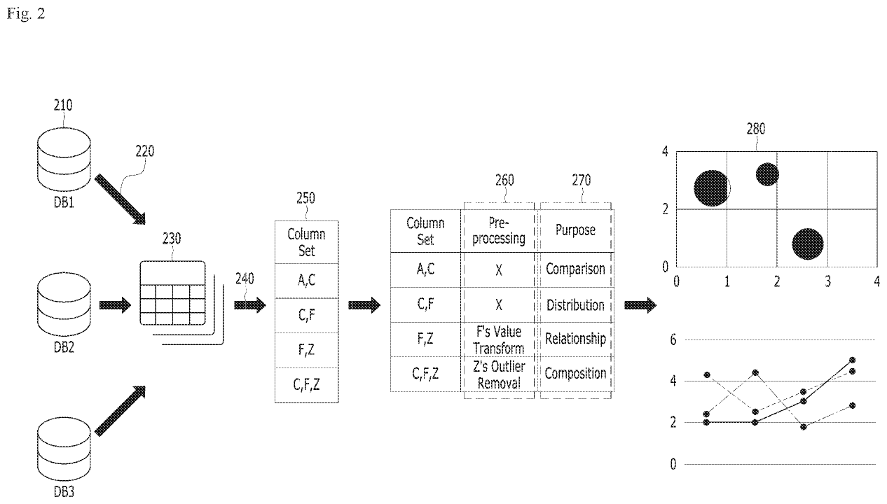

Hereinafter, a method of analyzing data will be described. FIG. 2 is a diagram illustrating an example of a method of analyzing data according to an exemplary embodiment of the present disclosure. The processor 120 may determine analysis target data based on a data set, determine an analysis scenario based on the analysis target data, and generate an analysis result for the analysis target data based on the analysis scenario. The method of analyzing data will be described with reference to FIG. 2.

The processor 120 may determine analysis target data based on a data set 230.

The data set 230 may be a set of at least a part of the data stored in a database. The processor 120 may receive information related to data stored in the database from a database stored in at least one of another computing device and a server through the network unit 110, and determine the data set 230 based on the received information about the data. Otherwise, the processor 120 may determine the data set 230 based on data stored in the database that is the memory 130 included in the computing device 100. The particular description for the foregoing generation of the data set 230 is merely an example, and the present disclosure is not limited thereto.

The data set 230 may include data included in two or more heterogeneous databases 210. The processor 120 may receive information about data from two or more heterogeneous databases 210 through the network unit 110, and generate the data set 230 based on at least a part of data in the data stored in each of the two or more heterogeneous databases 210. The information about the data may also be the information of the data itself or information for describing the data. The information of the data itself may be, for example, a value of 24 billion won, which is data about company A's 2019 sales. The information for describing data may be, for example, a data storage location, a column or a row including data, or table information. For example, the information for describing data may be information about a data table related to company A, a column related to department B in the data table, and the like. The particular description for the foregoing information about the data is merely an example, and the present disclosure is not limited thereto.

The processor 120 may receive data from two or more databases, and generate the data set 230 based on the received data. When the two or more databases are the heterogeneous databases 210, the processor 120 may perform pre-processing 220 for the data received from the two or more databases. The data included in the heterogeneous databases 210 may be the data stored by different formats, references, and the like, and thus, the data may be incompatible. The processor 120 may perform preprocessing 220 in order to perform a data analysis based on one reference or method on the data received from the two or more databases.

The processor 120 may perform the preprocessing 220 of the data based on the kind of database in which the data included in the data set 230 is stored. For example, even in the case of two or more databases distributed in different companies or the databases distributed in the same company, when the databases store data by different formats or references, the processor 120 may perform the preprocessing 220 on the data collected from each of the databases.

The preprocessing 220 may be an operation for grouping the data collected from two or more databases into one and processing the data. The preprocessing 220 may be an operation of transforming data collected from two or more databases. For example, the preprocessing 220 may be an operation of transforming a format of the data or adjusting at least a part of a value. The particular description for the foregoing preprocessing is merely an example, and the present disclosure is not limited thereto.

The processor 120 may determine analysis target data based on the data set 230.

When the database includes a large amount of data, in order to provide a result of analyzing data of interest to the user, the processor 120 may determine analysis target data which is data that users may be interested in among the large amount of data. The processor 120 may determine analysis target data in the data set 230 in order to provide a user with a data analysis combination which a user may be interested in among the analysis combinations of the data included in the data set 230. The analysis target data may be a sub set of the data set. The analysis target data may be a part of the data set determined to be provided to the user by analyzing the data set by the processor 120. The analysis target data may be a set of data that the user is expected to be interested in among one or more data included in the data set. The processor 120 may determine analysis target data in the data set by analyzing the data set and additional information for selecting analysis data in the data set.

The data set may be a set of data stored in the database. The data set may be at least a part of the entire data stored in the database. The data set may be a set of at least a part of tables, columns, or rows stored in the database. The data may be stored in a data storage place in the database. The data storage place may be referred to as a table. The table may include one or more rows, and each of the one or more rows may include one or more columns.

The processor 120 may output the analysis target data by using the data set as an input of an analysis target data determination model including one or more pre-trained network functions.

In the present invention, the network function may be exchangeably used with an artificial neural network and a neural network. In the present specification, the network function may also include one or more neural networks, and in this case, an output of the network function may be an ensemble of an output of one or more neural networks.

In the present specification, a model may include a network function. The model may also include one or more network functions, and in this case, an output of the model may be an ensemble of the output of one or more network functions.

Hereinafter, a learning method of the analysis target data determination model will be described.

According to the exemplary embodiment of the present disclosure, the analysis target data determination model may be a model trained by using training data including a data set as an input and additional information for determining analysis target data in the data set as additional information. More particularly, according to the exemplary embodiment of the present disclosure, the analysis target data determination model may be a model trained by using training data including a data set as an input, and at least one of an analysis purpose, user selection data, and user information as an additional input, and the analysis target data as a label.

The analysis purpose may be information about a purpose that a user wants to analyze by using the data included in the data set. The analysis purpose may also be information about a correlation of the data to be analyzed or information desired to be acquired from data to be analyzed. For example, information about a correlation of the data to be analyzed may be information about comparison, distribution, relationship, and composition of the data. When an additional input is the analysis purpose, the processor 120 may determine data corresponding to the analysis purpose in the data included in the data set as the analysis target data. For example, the analysis purpose is the comparison of data, the analysis target data may be data for each of 2018 and 2019 for the same item (that is, for example, the number of times of usage of annual leave of employees). For example, when the information desired to be acquired from data to be analyzed is information related to a method of increasing an annual salary, the analysis target data may be performance data for other employees whose salaries are higher than a user. The particular description for the foregoing analysis purpose is merely an example, and the present disclosure is not limited thereto.

The user selection data may include information related to a selection of a user for data included in the data set. For example, the user selection data may be information about at least a part of the data which a user desires to analyze in the data included in the data set. The processor 120 may determine the analysis target data based on the data included in the user selection data. The processor 120 may also determine the data included in the user selection data as the analysis target data, or may also determine the data included in the user selection data and data relevant to the data included in the user selection data as the analysis target data. According to the exemplary embodiment of the present disclosure, when the processor 120 receives the user selection data as additional input data of the analysis target data determination model, the processor 120 may make the analysis target data determination model learn relevancy of the data in order to determine the user selection data and the data relevant to the user selection data as analysis target data. For example, in the case where the user selection data is salary data of employees of company A, data relevant to the user selection data may be the education or departments of the employees of company A. In the case where the salary data of employees of company A is input as the user selection data, the analysis target data determination model of the exemplary embodiment of the present disclosure may select data (for example, the education and the department) relevant to the salary data as analysis target data. The particular description for the foregoing user selection data is merely an example, and the present disclosure is not limited thereto.

The user information may include at least one of user general information or user history information.

The user general information may include at least one of identification information for distinguishing a user from another user and group information including information about a group of the user.

According to the exemplary embodiment of the present disclosure, the identification information for distinguishing a user from another user may be information for providing an analysis result similar to an existing analysis pattern based on data analysis history information of a user identified based on user identification information. For example, the processor may recommend data similar or related to past analysis target data based on a selection history of analysis target data by a specific user. For example, according to a data analysis history of a user identified based on user identification information, when user A analyzes data related to column F included in the data set several times, the processor 120 may determine the data related to column F as analysis target data for user A. The particular description for the foregoing history information is merely an example, and the present disclosure is not limited thereto.

According to another exemplary embodiment of the present disclosure, the identification information for distinguishing a user from another user may be information for providing a user with an analysis result based on a data analysis result of another user having an analysis pattern similar to an analysis pattern of the user based on data analysis history information of the user identified based on user identification information. For example, the processor 120 may identify another user who selects analysis data similar or related to past analysis data of a past analysis history on the basis of the past analysis history of a user requesting the determination of analysis target data, and select analysis target data based on an analysis history of another identified user. For example, there is data analysis history information indicating that users A and B performed a data analysis on column D included in data set C and data analysis history information indicating that user A performed a data analysis on column F included in data set E, the processor 120 may output data related to column F in data set E as analysis target data for user B by using the analysis target data determination model. The particular description for the foregoing identification information is merely an example, and the present disclosure is not limited thereto.

The group information including the information related to the group of the user may be information for providing an analysis result similar to an analysis pattern of the group based on the information about the group of the user. In the exemplary embodiment of the present disclosure, the group information may include information related to one or more references based on which users may be classified. For example, the group information may include information related to a group to which a user belongs. For example, the information related to a group of a user may be a characteristic, such as a company, work, and a department, to which the user belongs. For example, when the processor 120 receives group information indicating that a user belongs to a general affairs team as an additional input, the processor 120 may make the analysis target data determination model determine analysis target data based on data analysis histories of other users belonging to the general affairs team. Further, for example, when the processor 120 receives the group information of the user as an additional input, the analysis target data determination model may determine data related to the group to which the user belongs as analysis target data. For example, when the processor 120 receives the group information indicating that a user belongs to a general affairs team as an additional input, the processor 120 may make the analysis target data determination model determine data related to the work of the general affairs team as analysis data. The particular description for the foregoing group information is merely an example, and the present disclosure is not limited thereto.

The user history information may be information related to a data analysis characteristic of a user. According to the exemplary embodiment of the present disclosure, when the processor 120 receives the user history information as an additional input, the processor 120 may determine analysis target data for a data analysis having a pattern similar or related to a data analysis history of the user. According to another exemplary embodiment of the present disclosure, when the processor 120 receives the user history information as an additional input, the processor 120 may determine analysis target data of the user based on analysis target data included in a data analysis history for an input data set of another user having a data analysis history having a pattern similar or related to the data analysis history of the user. The particular description for the foregoing user history information is merely an example, and the present disclosure is not limited thereto.

According to the exemplary embodiment of the present disclosure, the processor 120 may preprocess at least one of the analysis purpose, the user selection data, and the user information and input the processed one as an additional input of the analysis target data determination model. The preprocessing for the additional input may be a transformation for the additional input data. For example, the processor 120 may perform preprocessing on the additional input data by using one-hot encoding. The one-hot encoding may be a vector expression scheme that determines the number of types of items as a dimension of a vector, assigns a value of 1 to an index of a corresponding item, and assigns a value of 0 to indexes of other items. The processor 120 may determine a unique index corresponding to an item included in information (that is, in the present example, at least one of the analysis purpose, the user selection data, and the user information) desired to be input to the analysis target data determination model as an additional input. The processor 120 may determine a value of a location of an index of an item desired to be input to the analysis target data determination model as an additional input as 1, and determine a value of a location of an index of another item as 0. For example, when the analysis purpose is the analysis for a sale improvement item, the processor 120 may generate a one-hot vector having a value of 1 at a location of an index of an item related to sales and a value of 0 at locations of indexes of the remaining items and input the one-hot vector as an additional input. The particular description for the foregoing additional input preprocessing is merely an example, and the present disclosure is not limited thereto.

The training data may include the data set as an input, include at least one of the analysis purpose, the user selection data, and the user information as an additional input, and the analysis target data as a label. The training data may be generated based on the data analysis histories of the users.

The analysis target data determination model of the exemplary embodiment of the present disclosure may be a model supervised-learned model so that analysis target data is output by inputting the data set and the additional input. The analysis target data determination model may output the analysis target data based on the data set, and differently process the data set according to the additional input to output different analysis target data. For example, the analysis target data determination model may receive the data set and the user information and differently process the data set according to the user information to output analysis target data according to the user information.

According to the exemplary embodiment of the present disclosure, the analysis target data determination model may be a model trained by using training data generated based on a feedback for the analysis target data of the users. The processor 120 may generate training data based on analysis results for data analyzed in the data set by the users. The processor 120 may use the data sets analyzed by the users as an input of the training data and the analysis target data that is the basis of the analysis result derived from the data sets of the users or the analysis target data extracted from the data set as a label of the training data.

According to the exemplary embodiment of the present disclosure, the processor 120 may not use all of the data sets and analysis target data included in the data analysis histories of the users as the training data, but may use at least a part of the data sets and analysis target data as the training data. The processor 120 may set only the analysis result in which the number of times the users use is equal to or larger than a predetermined threshold value among the analysis results of the users as a basis of the training data. For example, the case where the users use the analysis result may mean an operation of sharing the analysis result with another person, or storing or downloading the analysis result. For example, when a user analyzes column B in data set A and the number of times of downloading the analysis result is one, and when the user analyzes table C in data set A, the number of times of downloading the analysis result is three, and the number of times of sharing the analysis result is twelve, the processor 120 may generate training data only for table C without generating training data for column B. The particular description for the foregoing training data is merely an example, and the present disclosure is not limited thereto.

According to another exemplary embodiment of the present disclosure, the processor 120 may generate training data so that at least a part of the data sets included in the data analysis histories of the users is matched to the additional input. The processor 120 may generate training data including the data set as an input, including at least one of the analysis purpose, the user selection data, and the user information as an additional input, and including the analysis target data as a label.

In this case, the processor 120 may also generate training data so that the analysis result in which the number of times the users use is smaller than the predetermined threshold value among the analysis results of the users is matched to the additional input. For example, in the case of the analysis target data set extracted from the data set according to an analysis pattern generally used by the users, the number of times the users use the analysis target data may be equal to or larger than a threshold value, and in the case of a generally used analysis pattern, the processor 120 may generate training data including the data set as an input and including the analysis target data as a label. Further, for example, in the case of the analysis target data set extracted from the data set according to an analysis pattern which the users do not generally use and the number of times the users use the analysis target data is less than the threshold value, the processor 120 may generate training data including the data set as an input, including at least one of the analysis purpose, the user selection data, and the user information as an additional input, and including the analysis target data as a label. For example, when a user of group D analyzes column B in data set A and the number of times of downloading the analysis result is one, and the user analyzes table C in data set A, and the number of times of downloading the analysis result is three, and the number of times of sharing the analysis result is twelve, the processor 120 may generate training data so as to include an additional input related to group D in relation to column B, and may also generate both training data including an additional input related to group D and training data including no additional input related to group D in relation to table C. The particular description for the foregoing training data is merely an example, and the present disclosure is not limited thereto. The processor 120 may generate the analysis target data determination model including one or more network functions. The processor 120 may generate the analysis target data determination model formed of one or more network functions including at least one of an input layer, one or more hidden layer, and an output layer. The processor 120 may generate a network function formed of an input layer including one or more input nodes. The processor 120 may generate a network function so that the hidden layer included in the network function includes one or more hidden nodes. The processor 120 may generate a network function so that the output layer included in the network function includes one or more output nodes. The processor 120 may generate the network function so that the nodes included in the layer of the network function are connected to one or more nodes of another layer through links, respectively. A weight may be set to each link.

The processor 120 may input the data set of the training data as an input of the analysis target data determination model. The processor 120 may input the data set of the training data to one or more input nodes included in the input layer of the analysis target data determination model. The input data set may be the data set itself, the preprocessed data set, or meta information about the data set. The processor 120 may input at least one of the analysis purpose, the user selection data, and the user information which are the additional input of the training data as an input of the analysis target data determination model. The processor 120 may input the data set included in the training data and at least one of the analysis purpose, the user selection data, and the user information which are the additional input included in the training data to each of one or more input nodes included in the input layer of the analysis target data determination model. The particular description for the foregoing input of the analysis target data determination model is merely an example, and the present disclosure is not limited thereto.

The processor 120 may generate an analysis target data determination model including an input layer, one or more hidden layers, and an output layer. The layer may include one or more nodes. The node may be connected to another node through a link. The processor 120 may compute the data set and the additional input input to the input node of the input layer of the analysis target data determination model through the link connected with the input node and propagate a value of the computation to the hidden layer. The computation may include a predetermined mathematical computation. For example, the computation may be a multiplication or a convolution, but the foregoing description is merely an example, and the present disclosure is not limited thereto. The processor 120 may compute the item input to the input node of the analysis target data determination model through the link connected with the input node and propagate a value of the computation to the output layer via one or more hidden layers. The processor 120 may generate analysis target data based on the value propagated to the output layer of the analysis target data determination model.

The processor 120 may derive a first node value of a first node of the analysis target data determination model by computing a second node value of a second node included in a previous layer connected with the first node and a first link weight of a link set as a link connecting the second node included in the previous layer and the first node. The processor 120 may propagate the first node value of the first node of the analysis target data determination model to a third node by computing with a second link weight set to a link connecting the third node included in a next layer connected with the first node.

In order to generate the analysis target data determination model, the processor 120 may input each of the data set and the additional input including at least one of the analysis purpose, the user selection data, and the user information included in the training data to one or more input nodes included in the input layer of the analysis target data determination model, and compare the analysis target data (that is, the output) computed in the output layer of the analysis target data determination model and the analysis target data (that is, a correct answer) that is the label included in the training data to calculate an error. The processor 120 may adjust the weight of the analysis target data determination model based on the error. The processor 120 may update the weight set to each link by propagating the value from the output layer included in one or more network functions of the analysis target data determination model to the input layer via one or more hidden layers based on the error.

According to another exemplary embodiment of the present disclosure, the processor 120 may generate re-training data based on the feedback of the user for the trained analysis target data determination model. The processor 120 may generate re-training data based on a feedback of a user for the analysis target data output from the analysis target data determination model or an analysis result based on the analysis target data. The processor 120 may use the analysis target data output from the analysis target data determination model or the analysis result based on the analysis target data as the basis of the re-training data for the analysis result in which the number of times the user uses is equal to or larger than the predetermined threshold value. For example, when the users share the analysis result for column B in data set A several times and store the analysis result, the processor 120 may generate re-training data based on the corresponding history. That is, the processor 120 may generate re-training data based on a feedback of the user for the result of the selection of the analysis target data. For example, according to the exemplary embodiment of the present disclosure, when the analysis target data selected by the analysis target data determination model is used for the user, the selection of the analysis target data is appropriate, so that the analysis target data is generated as new training data (that is, re-training data) to update the model. When the pre-trained analysis target data determination model is updated by using the re-training data, accuracy of the analysis target data determination model may be improved.

The processor 120 may update the trained analysis target data determination model by using the re-training data. The processor 120 may train the updated analysis target data determination model sharing at least a part of the initial weight with the trained analysis target data determination model by using the re-training data. When the initial weight of the updated analysis target data determination model shares at least a part of the weight of the trained analysis target data determination model and the updated analysis target data determination model is trained by using the re-training data to which the feedbacks of the users are reflected, it is possible to increase a speed of training the model and generate a model having higher accuracy than that of the existing trained analysis target data determination model.

According to another exemplary embodiment of the present disclosure, the analysis target data determination model may be the model trained for relevancy between two or more items included in the data set. According to the exemplary embodiment of the present disclosure, the analysis target data determination model may be the model trained for relevancy between the two or more items based on the analysis items included in the data analysis histories of the users. The processor 120 may check the analysis items included in the data analysis histories of the users. The analysis item may be at least one of data, a data table, a data column, a data row, and a grouping reference of data included in the data set. For example, the analysis target data determination model may be trained so that the data of column F is highly relevant to the data of column B based on the data history that the users analyze the data of column F and the data of column B in data set A together. For example, the analysis target data determination model may be trained so that the data item related to the annual salary is highly related to the data items related to the annual leave based on the data history that the data item (that is, the grouping reference of the data) related to the annual salaries of the users and the data items related to the annual leave are analyzed together. The particular description for the foregoing relevancy between the items is merely an example, and the present disclosure is not limited thereto.

Hereinafter, a method of outputting analysis target data by using the trained analysis target data determination model will be described.

The processor 120 may input the data set 230 to the analysis target data determination model 240 including one or more pre-trained network functions, and output analysis target data 250 by using the analysis target data determination model 240.

The processor 120 may input at least one of an analysis purpose, user selection data, and user information as an additional input of the analysis target data determination model 240. The processor 120 may compute the data set 230 and the additional input by using the analysis target data determination model 240 to output the analysis target data 250. As described above, the analysis purpose may be information about the purpose that the user intends to analyze the data by using the data included in the data set 230. As described above, the user selection data may be information about at least a part of the data which a user desires to analyze in the data included in the data set 230. The processor 120 may compute the user selection data by using the analysis target data determination model 240 that is the trained model for relevancy between two or more items included in the data set 230, and determine the user selection data and the data relevant to the user selection data as the analysis target data 250. As described above, the user information may include at least one of user general information including at least one of identification information for distinguishing a user from another user and group information including information about a group of the user, and user history information that is information on a data analysis characteristic of a user.

The processor 120 may also output one analysis target data in the data set by using the analysis target data determination model, or also output two or more analysis target data having high score. When the processor 120 outputs the two or more analysis target data by using the analysis target data determination model, the processor 120 may also generate an analysis result based on each of the two or more analysis target data and provide the user with the generated analysis results.

Hereinafter, a method of determining, by the processor 120, an analysis scenario will be described.

The processor 120 may determine an analysis scenario 270 based on the analysis target data. The analysis scenario 270 may be an analysis method of the analysis target data. The analysis scenario 270 may be a method of effectively transferring information about the analysis target data to a user. The analysis scenario 270 may be, for example, information about comparison, distribution, relationship, and composition of the analysis target data. The particular description for the foregoing analysis scenario is merely an example, and the present disclosure is not limited thereto.

The processor 120 may determine the analysis scenario 270 based on the analysis target data and at least one of a characteristic of the analysis target data, the analysis purpose, and the user information.

According to the exemplary embodiment of the present disclosure, the processor 120 may determine the analysis scenario based on the analysis scenario 270 corresponding to at least one of the item to which the analysis target data included in the data analysis histories of the users belongs or the analysis purpose.

The characteristic of the analysis target data may be information about contents of the data included in the analysis target data. The processor 120 may determine the analysis scenario 270 based on analysis scenario information analyzed according to the characteristic of the analysis target data included in the data analysis histories of the users. The processor 120 may match the analysis scenario to the characteristic of the analysis target data and store the analysis scenario in the memory 130. For example, in the case where the characteristic of the analysis target data is time series, a comparison analysis scenario may be matched and stored in the memory 130, and in the case where the characteristic of the analysis target data includes a plurality of analysis items, a relationship analysis scenario may be matched and stored in the memory 130. For example, in the case where the analysis target data includes time series data, the processor 120 may also determine to analyze the analysis target data based on a comparison scenario, or in the case where the analysis target data includes two or more different items, the processor 120 may also determine to analyze the analysis target data based on a relationship scenario. For example, when the analysis target data is the positions of the employees in the company and the annual salaries of the employees in the company based on the data analysis histories of the users, the processor 120 may also determine to analyze the analysis target data based on the relationship scenario. The particular description for the foregoing analysis scenario is merely an example, and the present disclosure is not limited thereto.

As described above, the analysis purpose may be information about a purpose that a user wants to analyze by using the data included in the data set. The analysis purpose may also be information about a correlation of the data to be analyzed or information desired to be acquired from data to be analyzed. When the user inputs information about a correlation of the data to be analyzed as an additional input of the analysis target data determination model, the processor 120 may determine the analysis scenario 270 based on the analysis purpose. The processor 120 may determine the analysis scenario 270 corresponding to the analysis purpose. For example, when the user inputs information about the purpose of the data analysis that the user wants to know the distribution of the data as an additional input of the analysis target data determination model, the processor 120 may determine the analysis scenario 270 with the scenario for the distribution. The particular description for the foregoing analysis scenario is merely an example, and the present disclosure is not limited thereto.

According to the exemplary embodiment of the present disclosure, the processor 120 may determine the analysis scenario based on the analysis scenario 270 included in the data analysis history of the user based on the user information. The processor 120 may check the kind of analysis scenario 270, through which the user performed the data analysis a lot, based on the analysis history of the user, and when there is a pattern of the analysis scenario 270 preferred by the user, the processor 120 may determine the analysis scenario 270 based on the corresponding analysis scenario. For example, when the user performs the data analysis based on the analysis scenario for the distribution of the data a lot, the processor 120 may determine the analysis scenario 270 based on the distribution. The particular description for the foregoing analysis scenario is merely an example, and the present disclosure is not limited thereto.

The processor 120 may determine a preprocessing method 260 for the analysis target data in order to perform the analysis scenario 270. The preprocessing for the analysis target data may mean an operation of transforming at least a part of the data included in the analysis target data in order to effectively analyze the analysis target data. For example, the preprocessing for the analysis target data may include value transformation, removal of an outlier, standardization, and imputation. The outlier may be data that distorts the results of data analysis in a data set or threatens the appropriateness of the data analysis. For example, the outlier may also include a value obtained by a measurement error, a collection error, and the like, and may also be data deviating from a normal data range. For example, the value transformation may be performed in the analysis scenario 270 for showing linearity of the data, the removal of the outlier may be performed in the analysis scenario 270 for showing normality of the data set, the standardization may be performed in the analysis scenario 270 for the comparison and analysis of the data included in the various items, and the imputation may be performed for supplementing missing data. The particular description for the foregoing preprocessing method for the analysis target data is merely an example, and the present disclosure is not limited thereto.

According to the exemplary embodiment of the present disclosure, the processor 120 may determine the analysis scenario 270 by using a pre-trained analysis scenario determination model. The processor 120 may generate training data which includes the analysis target data as an input, at least one of the characteristic of the analysis target data, the analysis purpose, and the user information as an additional input, and the analysis scenario as a label of the training data based on the data analysis histories of the users. The processor 120 may train the analysis scenario determination mode including one or more network functions by using the training data. The processor 120 may output the analysis scenario 270 by inputting the analysis target training data as the input of the trained analysis scenario determination model and at least one of the characteristic of the analysis target data, the analysis purpose, and the user information as the additional input and computing the analysis target training data and the additional input.

According to another exemplary embodiment of the present disclosure, the processor 120 may generate the training data including the analysis scenario and the preprocessing method 260 for the analysis target data as an additional label based on the data analysis histories of the users. The processor 120 may train the analysis scenario determination model by using the training data including the preprocessing method 260 as the additional label. The analysis scenario determination model may be trained so as to output the analysis scenario by using the analysis target data as the input. Further, the analysis scenario determination model may be trained so as to output the analysis scenario and the preprocessing method for the analysis target data by using the analysis target data as the input.

In another exemplary embodiment of the present disclosure, the analysis scenario determination model may be trained so as to output at least one of the analysis scenario and the preprocessing method by using the analysis target data and the additional input (for example, at least one of the characteristic of the analysis target data, the analysis purpose, and the user information) as the input. The processor 120 may output the analysis scenario 270 and the preprocessing method 260 for the analysis target data by inputting the analysis target training data as the input of the trained analysis scenario determination model and at least one of the characteristic of the analysis target data, the analysis purpose, and the user information as an additional input and computing the analysis target training data and the additional input.

The processor 120 may generate an analysis result 280 for the analysis target data based on the analysis scenario 270. The analysis result 280 may be a result of the analysis for the analysis target data to be provided to the user. The analysis result 280 may be generated in various forms that may be checked by the user. For example, the analysis result 280 may include a table, a text, a visualization material, and the like. The particular description for the foregoing analysis result is merely an example, and the present disclosure is not limited thereto.

The processor 120 may generate the analysis result 280 based on at least one of the characteristic of the analysis scenario, the analysis purpose, and the user information.

The processor 120 may generate the analysis result 280 for the analysis target data based on the characteristic of the analysis scenario or the analysis purpose.

The characteristic of the analysis scenario may be information about the purpose of the analysis through the analysis scenario. The characteristic of the analysis scenario may be the characteristic of the analysis scenario determined by the processor 120 based on the analysis target data. Further, the characteristic of the analysis scenario may be the characteristic for the analysis scenarios output by computing the analysis target data by the processor 120, not the additional information input by the user. For example, the characteristic of the analysis scenario may be the characteristic for the analysis scenarios output by computing, by the processor 120, the analysis target data by using the analysis scenarios determination model. The characteristic of the analysis scenario may be a concept corresponding to the analysis purpose. The characteristic of the analysis scenario may be information about comparison, distribution, relationship, and composition of the data. For example, a data visualization method that is the method of providing the data analysis result 280 matched to each characteristic of the analysis scenario may be stored in the memory 130. For example, in the case where the characteristic of the analysis scenario is for deriving a comparison result of data, the data is visualized by using a bar chart, a column chart, a line chart, and the like, in the case where the characteristic of the analysis scenario is for deriving information about the distribution of the data, the data is visualized by using a scatter chart, an area graph, and the like, in the case where the characteristic of the analysis scenario is for deriving information about a relationship of the data, the data is visualized by using a scatter chart, a bubble chart, and the like, and in the case where the characteristic of the analysis scenario is for deriving information about a composition of the data, the data is visualized by using a pie chart, a stacked area chart, and the like, to generate the analysis result 280 for the analysis target data. The particular description for the foregoing analysis result is merely an example, and the present disclosure is not limited thereto.

As described above, the analysis purpose may be information about a purpose that a user wants to analyze by using the data included in the data set. The analysis purpose may be information about comparison, distribution, relationship, and composition of the data. For example, a data visualization method that is the method of providing the data analysis result 280 matched to each analysis purpose may be stored in the memory 130. For example, in the case where the data analysis purpose is for deriving a comparison result of data, the data is visualized by using a bar chart, a column chart, a line chart, and the like, in the case where the data analysis purpose is for deriving information about the distribution of the data, the data is visualized by using a scatter chart, an area graph, and the like, in the case where the data analysis purpose is for deriving information about a relationship of the data, the data is visualized by using a scatter chart, a bubble chart, and the like, and in the case where the data analysis purpose is for deriving information about a composition of the data, the data is visualized by using a pie chart, a stacked area chart, and the like, to generate the analysis result 280 for the analysis target data. The particular description for the foregoing analysis result is merely an example, and the present disclosure is not limited thereto.

The processor 120 may generate the analysis result 280 for the analysis target data based on the user information. The processor 120 may generate the analysis result 280 according to a preferable analysis pattern of the user based on the data analysis history of the user. For example, on the basis of the data analysis history of the user, when the user prefers the visualization analysis by using the scatter chart between the scatter chart and the area graph for the analysis scenario, the processor 120 may generate the analysis result 280 by using the scatter chart. The particular description for the foregoing analysis result is merely an example, and the present disclosure is not limited thereto.

According to the exemplary embodiment of the present disclosure, the processor 120 may assign a weight to anomaly data in one or more data included in the data set and determine the analysis target data. The anomaly data may be data having unusual pattern among one or more data included in the data set. The processor 120 may determine the analysis target data so as to include the anomaly data. For example, when only the salary data for one of the employees at the same position of the same department has an abnormally high value, the processor 120 may determine the data having a different pattern from a general pattern of the salary data included in the data set as anomaly data and determine the analysis target data so as to include the anomaly data. In the foregoing example, the processor 120 may determine the analysis target data so as to include the anomaly data and the data related to the anomaly data. The particular description for the foregoing analysis target data is merely an example, and the present disclosure is not limited thereto.

According to the exemplary embodiment of the present disclosure, the processor 120 may assign a weight to the anomaly data in one or more data included in the analysis target data and determine the analysis scenario. For example, when the data of the year of 2018 among the data of years 2017, 2018, and 2019 which are the time serial data is anomaly data, the processor 120 may determine the analysis scenario based on the comparison. For example, when only the salary data for one of the employees at the same position of the same department has an abnormally high value, the processor 120 may determine the analysis scenario based on the relationship of the data included in the items of each of the annual salary and performance. The particular description for the foregoing analysis scenario is merely an example, and the present disclosure is not limited thereto.

According to the exemplary embodiment of the present disclosure, the processor 120 may assign a weight to the anomaly data in one or more data included in the analysis target data and generate the analysis result 280. The anomaly data may be, for example, data having an abnormal value differently from other data among the data belonging to the same table, and data having an abnormal value differently from other years among the data based on the year for the same item. When there are the anomaly data, the processor 120 may generate the analysis result 280 for analyzing a characteristic for the anomaly data. For example, when there are the anomaly data, the processor 120 may generate the analysis result 280 by generating a visualization material so that the anomaly data is visually stood out. The particular description for the foregoing analysis of the anomaly data is merely an example, and the present disclosure is not limited thereto.

According to another exemplary embodiment of the present disclosure, the processor 120 may generate the analysis result 280 by assigning a weight to the anomaly data in one or more data included in the data set. When there is the anomaly data in one or more data included in the data set, the processor 120 may determine the anomaly data, or the anomaly data and the data related to the anomaly data as the analysis target data. The processor 120 may determine the analysis scenario 270 based on the anomaly data included in the analysis target data. The processor 120 may determine the analysis scenario 270 so that the user may check the anomaly data or the data relevant to the anomaly data based on the anomaly data included in the analysis target data. The processor 120 may generate the analysis result 280 corresponding to the analysis scenario 270 based on the anomaly data. For example, when the data set includes the data related to the rate of employee resignation by year and an abnormally large number of retirees occurred in 2017, the processor 120 may determine the value of the rate of the employee resignation in 2017 as the anomaly data, and the processor 120 may determine the data including the value of the rate of the employee resignation in 2017 and performance-related pay data of the employees in 2017 relevant to the value of the rate of the employee resignation in 2017 as the analysis target data. The processor 120 may determine the analysis scenario 270 corresponding to a relationship of the data including the value of the rate of the employee resignation in 2017 and the performance-related pay data of the employees in 2017, and generate the analysis result 280 that is the visualization material showing the relevancy. The particular description for the foregoing analysis of the anomaly data is merely an example, and the present disclosure is not limited thereto.

The processor 120 may be operated as a part of a Database Management System (DBMS). When a frontend of the DBMS receives a query, the processor 120 may perform query optimization for processing the corresponding query. The processor 120 may check status information based on each column included in the data table for the query optimization. The status information based on each column may be checked based on a status table operated in the DBMS. The status table may include information about at least one of status (for example, a change, a storage, and a deletion) of the data included in the data table, the values of the data, and changes in the values of the data. The processor 120 may check the anomaly data based on the status table. The processor 120 may perform a separate operation for checking the anomaly data, or may check the anomaly data based on the status table without a need to generating a separate table. For example, the processor 120 may check the anomaly data by using a minimum value, a maximum value, density information, a standardized score (Z-score), and an Inter Quartile Range (IQR) of the status table including status information for each column. The particular description for the foregoing check of the anomaly data is merely an example, and the present disclosure is not limited thereto.

In the case of the data managed by a company, the monitoring for the anomaly data may be important. For example, when sales for a specific area are sharply dropped in the data set for the sales, the corresponding sales may be anomaly data, and for the company managing the data, analyzing a reason for the anomaly data or recognizing a result may be important. According to the exemplary embodiment of the present disclosure, when the analysis for the anomaly data is provided, a positive influence may be given to a company data management.

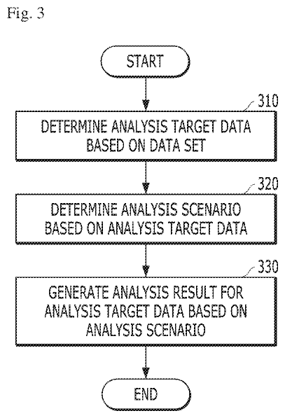

FIG. 3 is a flowchart of the method of analyzing data according to an exemplary embodiment of the present disclosure.

A data set may be a set of at least a part of the data stored in a database. The data set may include data included in two or more heterogeneous databases. The computing device 100 may receive information about the data from the two or more heterogeneous databases and generate a data set based on at least a part of the data stored in each of the two or more heterogeneous databases.

The computing device 100 may perform preprocessing of the data based on the kind of database in which the data included in the data set is stored. The data included in the heterogeneous databases may be the data stored by different formats, references, and the like, and thus, the data may be incompatible. The computing device 100 may perform the preprocessing in order to perform a data analysis based on one reference or method on the data received from the two or more databases. The preprocessing may be an operation for grouping the data collected from two or more databases into one and processing the data. The preprocessing may be an operation of transforming data collected from two or more databases.

The computing device 100 may determine analysis target data based on the data set (310).

The computing device 100 may output the analysis target data by using the data set as an input of an analysis target data determination model including one or more pre-trained network functions. The analysis target data determination model may be a model trained by using training data including a data set as an input, at least one of an analysis purpose, user selection data, and user information as an additional input, and the analysis target data as a label.

The analysis purpose may be information about a purpose that a user wants to analyze by using the data included in the data set. The analysis purpose may also information about a correlation of the data to be analyzed or information desired to be acquired from data to be analyzed.

The user selection data may be information about at least a part of the data which a user desires to analyze in the data included in the data set. The computing device 100 may determine the analysis target data based on the data included in the user selection data. The computing device 100 may also determine the data included in the user selection data as the analysis target data, or may also determine the data included in the user selection data and data relevant to the data included in the user selection data as the analysis target data.

The user information may include at least one of user general information or user history information. The user general information may include at least one of identification information for distinguishing a user from another user and group information including information about a group of the user. According to the exemplary embodiment of the present disclosure, the identification information for distinguishing a user from another user may be information for providing an analysis result similar to an existing analysis pattern based on data analysis history information of a user identified based on user identification information. According to another exemplary embodiment of the present disclosure, the identification information for distinguishing a user from another user may be information for providing a user with an analysis result based on a data analysis result of another user having an analysis pattern similar to an analysis pattern of the user based on data analysis history information of the user identified based on user identification information. The group information including the information related to the group of the user may be information for providing an analysis result similar to an analysis pattern of the group based on the information about the group of the user. The user history information may be information related to a data analysis characteristic of a user.

The computing device 100 may preprocess at least one of the analysis purpose, the user selection data, and the user information and input the processed one as an additional input of the analysis target data determination model. The preprocessing for the additional input may be a transformation for the additional input data.

The analysis target data determination model may be a model trained by using training data generated based on a feedback for the analysis target data of the users.

The training data may include the data set as an input, include at least one of the analysis purpose, the user selection data, and the user information as an additional input, and the analysis target data as a label. The training data may be generated based on the data analysis histories of the users.

The analysis target data determination model may be the model trained for relevancy between two or more items included in the data set. The analysis target data determination model may be the model trained for relevancy between the two or more items based on the analysis items included in the data analysis histories of the users.

The analysis target data determination model may be a model trained by using training data generated based on a feedback for the analysis target data of the users. According to another exemplary embodiment of the present disclosure, the computing device 100 may generate re-training data based on the feedback of the user for the analysis target data determination model.

The computing device 100 may update the trained analysis target data determination model by using the re-training data. The computing device 100 may train the updated analysis target data determination model sharing at least a part of an initial weight with the trained analysis target data determination model by using the re-training data.

The computing device 100 may input at least one of the analysis purpose, the user selection data, and the user information as an additional input of the analysis target data determination model.

The computing device 100 may output the analysis target data by computing the data set and the additional input by using the analysis target data determination model.

The user information may include at least one of user general information including at least one of identification information for distinguishing a user from another user and group information including information about a group of the user, and user history information that is information on a data analysis characteristic of a user.

The computing device 100 may determine an analysis scenario based on the analysis target data (320). The computing device 100 may determine the analysis scenario based on the analysis target data. The analysis scenario may be an analysis method of the analysis target data. The analysis scenario may be a method of effectively transferring information about the analysis target data to a user.

The computing device 100 may determine a preprocessing method for the analysis target data in order to perform the analysis scenario. The preprocessing for the analysis target data may mean an operation of transforming at least a part of the data included in the analysis target data in order to effectively analyze the analysis target data.

The computing device 100 may determine the analysis scenario based on at least one of a characteristic of the analysis target data, the analysis purpose, and the user information.

The computing device 100 may determine the analysis scenario based on an analysis scenario corresponding to at least one of information about the contents included in the analysis target data included in data analysis histories of the users and the analysis purpose. The characteristic of the analysis target data may be information about contents of the data included in the analysis target data. The computing device 100 may determine the analysis scenario based on analysis scenario information analyzed according to the characteristic of the analysis target data included in the data analysis histories of the users. As described above, the analysis purpose may be information about a purpose that a user wants to analyze by using the data included in the data set. The analysis purpose may be also information about a correlation of the data to be analyzed or information desired to be acquired from data to be analyzed. According to the exemplary embodiment of the present disclosure, the computing device 100 may determine the analysis scenario based on the analysis scenario included in the data analysis history of the user based on the user information. The computing device 100 may check the kind of analysis scenario, through which the user performed the data analysis a lot, based on the analysis history of the user, and when there is a pattern of the analysis scenario preferred by the user, the computing device 100 may determine the analysis scenario based on the corresponding analysis scenario.

According to the exemplary embodiment of the present disclosure, the computing device 100 may determine the analysis scenario by using a pre-trained analysis scenario determination model. The computing device 100 may generate training data which includes the analysis target data as an input, at least one of the characteristic of the analysis target data, the analysis purpose, and the user information as an additional input, and the analysis scenario as a label of the training data based on the data analysis histories of the users. The computing device 100 may train the analysis scenario determination mode including one or more network functions by using the training data. The computing device 100 may output the analysis scenario by inputting the analysis target training data as the input of the trained analysis scenario determination model and at least one of the characteristic of the analysis target data, the analysis purpose, and the user information as the additional input and computing the analysis target training data and the additional input.

The computing device 100 may generate the training data including the analysis scenario and the preprocessing method for the analysis target data as an additional label based on the data analysis histories of the users.

The computing device 100 may determine the analysis scenario based on the analysis scenario included in the data analysis history of the user based on the user information. The analysis result may be a result of the analysis for the analysis target data to be provided to the user. The analysis result may be generated in various forms that may be checked by the user.

The computing device 100 may generate an analysis result for the analysis target data based on the analysis scenario (330).

The computing device 100 may generate the analysis result based on at least one of the characteristic of the analysis scenario, the analysis purpose, and the user information. As described above, the analysis purpose may be information about a purpose that a user wants to analyze by using the data included in the data set. The characteristic of the analysis scenario or the analysis purpose may be information about comparison, distribution, relationship, and composition of the data. The computing device 100 may generate the analysis result according to a preferable analysis pattern of the user based on the data analysis history of the user.

The computing device 100 may assign a weight to anomaly data in one or more data included in the analysis target data and generate the analysis result. The anomaly data may be, for example, data having an abnormal value differently from other data among the data belonging to the same table, and data having an abnormal value differently from other years among the data based on the year for the same item. When there are the anomaly data, the computing device 100 may generate the analysis result for analyzing a characteristic for the anomaly data.

The computing device 100 may assign a weight to anomaly data in one or more data included in the data set and generate the analysis result. When there is the anomaly data in one or more data included in the data set, the computing device 100 may determine the anomaly data, or the anomaly data and the data related to the anomaly data as the analysis target data. The computing device 100 may determine the analysis scenario based on the anomaly data included in the analysis target data.

The computing device 100 may check the anomaly data based on a status table. The computing device 100 may perform a separate operation for checking the anomaly data, or may check the anomaly data based on the status table without a need to generating a separate table.

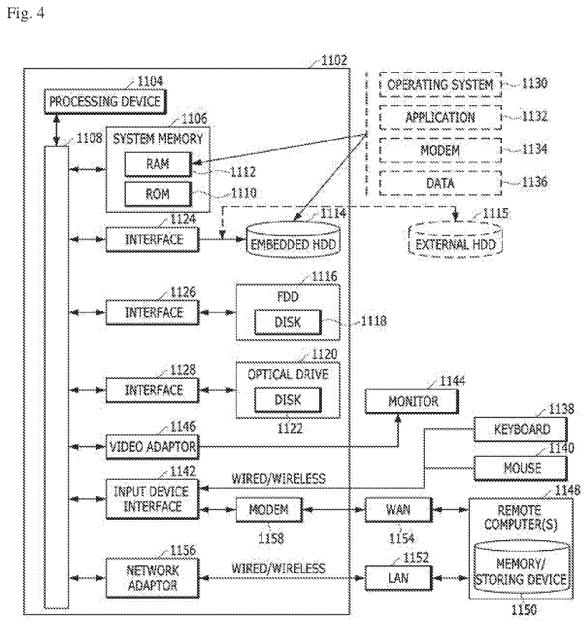

FIG. 4 is a block diagram of a computing device according to an exemplary embodiment of the present disclosure.

FIG. 4 is a simple and general schematic diagram for an example of a computing environment in which the exemplary embodiments of the present disclosure may be implemented.

The present disclosure has been generally described in relation to a computer executable command executable in one or more computers, but those skilled in the art will appreciate well that the present disclosure may be implemented in combination with other program modules and/or in a combination of hardware and software.

In general, a program module includes a routine, a program, a component, a data structure, and the like performing a specific task or implementing a specific abstract data type. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be positioned in both a local memory storage device and a remote memory storage device.

The computer generally includes various computer readable media. A computer accessible medium may be a computer readable medium regardless of the kind of medium. The computer readable medium includes volatile and non-volatile media and transitory and non-transitory media, and portable and non-portable media. As a non-limited example, the computer readable medium may include a computer readable storage medium and a computer readable transport medium. The computer readable storage medium includes volatile and non-volatile media, transitory and non-non-transitory media, portable and non-portable media constructed by a predetermined method or technology, which stores information, such as a computer readable command, a data structure, a program module, or other data. The computer storage medium includes a Read Only Memory (RAM), a Read Only Memory (ROM), Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally includes all of the information transport media, such as other transport mechanisms, which implement a computer readable command, a data structure, a program module, or other data in a modulated data signal. The modulated data signal means a signal, of which one or more of the characteristics of the signal are set or changed so as to encode information within the signal. As a non-limited example, the computer readable transport medium includes a wired medium, such as a wired network or a direct-wired connection, and a wireless medium, such as sound, radio frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various common processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an erasable and programmable ROM (EPROM), and an EEPROM, and the BIOS includes a basic routine helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for outer mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. The interface 1124 for implementing an outer mounted drive includes at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of predetermined data in an appropriate digital form. In the description of the computer readable storage media, the HDD, the portable magnetic disk, and the portable optical media, such as a CD, or a DVD, are mentioned, but those skilled in the art will appreciate well that other types of computer readable storage media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display device are also connected to the system bus 1108 through an interface, such as a video adapter 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a workstation, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, Internet.

When the computer 1102 is used in the LAN networking environment, the computer 1102 is connected to the local network 1152 through a wired and/or wireless communication network interface or an adapter 1156. The adapter 1156 may make wired or wireless communication to the LAN 1152 easy, and the LAN 1152 also includes a wireless access point installed therein for the communication with the wireless adapter 1156. When the computer 1102 is used in the WAN networking environment, the computer 1102 may include a modem 1158, is connected to a communication computing device on a WAN 1154, or includes other means setting communication through the WAN 1154 via the Internet and the like. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, electric fields or particles, optical fields or particles, or a predetermined combination thereof.

Those skilled in the art will appreciate that the various illustrative logical blocks, modules, processors, means, circuits, and algorithm operations described in relation to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable device. For example, the computer-readable medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein includes one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be arranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

1. A non-transitory computer readable medium storing a computer program, wherein when the computer program is executed by one or more processors of a computing device, then the computer program is configured to perform procedures for providing a method to analyze data, comprising:
wherein the procedures include
determining an analysis target data based on a data set;
determining an analysis scenario based on the analysis target data; and
generating an analysis result for the analysis target data based on the analysis scenario.

2. The non-transitory computer readable medium according to claim 1, wherein the determining an analysis target data based on a data set includes outputting the analysis target data by inputting the data set to an analysis target data determination model that includes one or more pre-trained network functions.

3. The non-transitory computer readable medium according to claim 2, wherein outputting the analysis target data by inputting the data set to an analysis target data determination model that includes one or more pre-trained network functions includes:
inputting at least one of analysis purpose, user selection data or user information as an additional input to the analysis target data determination model; and
outputting the analysis target data by computing the data set and the additional input using the analysis target data determination model.

4. The non-transitory computer readable medium according to claim 3, wherein the user information includes at least one of user general information or user history information, wherein the user general information includes at least one of identification information for distinguishing a user from other users or group information including information related to a group of the user, and wherein the user history information is an information related to the data analysis characteristics of a user.

5. The non-transitory computer readable medium according to claim 2, wherein the analysis target data determination model is a trained model using training data which includes a data set as an input, includes at least one of analysis purpose, user selection data or user information as an additional input, and includes analysis target data as a label.

6. The non-transitory computer readable medium according to claim 2, wherein the analysis target data determination model is a trained model using training data generated based on feedback of the analysis target data of users.

7. The non-transitory computer readable medium according to claim 2, wherein the analysis target data determination model is a model trained about a relationship between two or more items included in the data set.

8. The non-transitory computer readable medium according to claim 7, wherein the analysis target data determination model is a model trained about a relationship between the two or more items based on analysis items included in a data analysis history of users.

9. The non-transitory computer readable medium according to claim 1, wherein the procedures further include
determining a preprocessing method for the analysis target data to perform the analysis scenario.

10. The non-transitory computer readable medium according to claim 1, wherein the determining an analysis scenario based on the analysis target data includes
determining the analysis scenario based on at least one of characteristic of the analysis target data, analysis purpose or user information.

11. The non-transitory computer readable medium according to claim 10, wherein the determining the analysis scenario based on at least one of characteristic of the analysis target data, analysis purpose or user information includes at least one of:
determining the analysis scenario based on an analysis scenario corresponding to at least one of information about contents included in the analysis target data included in the data analysis history of users or the analysis purpose; or
determining the analysis scenario based on an analysis scenario included in a data analysis history of a user based on the user information.

12. The non-transitory computer readable medium according to claim 1, wherein the generating an analysis result for the analysis target data based on the analysis scenario includes
generating the analysis result based on at least one of characteristic of the analysis scenario, analysis purpose or user information.

13. The non-transitory computer readable medium according to claim 1, wherein the data set includes data included in two or more heterogeneous databases.

14. The non-transitory computer readable medium according to claim 1, wherein the procedures further include
performing preprocessing of a data based on a type of database in which the data included in the dataset is stored.

15. The non-transitory computer readable medium according to claim 1, wherein the generating an analysis result for the analysis target data based on the analysis scenario includes
generating the analysis result by assigning weight to an anomaly data among one or more data included in the analysis target data.

16. A method for providing data analysis, comprising:
determining an analysis target data based on a data set;
determining an analysis scenario based on the analysis target data; and
generating an analysis result for the analysis target data based on the analysis scenario.

17. A server for providing data analysis, comprising:
a processor including one or more cores; and
a memory;
wherein the processor is configured to
determine an analysis target data based on a data set;
determine an analysis scenario based on the analysis target data; and
generate an analysis result for the analysis target data based on the analysis scenario.
